(19) United States
(12) Patent Application Publication
(10) Pub. No.: US 2010/0182475 A1
(43) Pub. Date: Jul. 22, 2010

(54) BINOCULAR SYSTEM WITH DIGITAL CAMERA

(76) Inventor: Stefan Witte, Vastra Frolunda (SE)

Correspondence Address: HARNESS, DICKEY & PIERCE, P.L.C., P.O. BOX 8910, RESTON, VA, 20195, US

(21) Appl. No.: 12/733,266

(22) PCT Filed: Sep. 9, 2008
(86) PCT No.: PCT/EP2008/061894

§ 371 Date: Mar. 16, 2010

(30) Foreign Application Priority Data
Sep. 11, 2007 (EP) 07116162.4
Oct. 22, 2007 (EP) 07118998.9

(51) Int. Cl. H04N 5/335; H04N 5/222

(52) U.S. Cl. 348/308; 348/333.01; 348/333.08; 348/E05.045; 348/E05.091

(57) ABSTRACT

A viewing module is disclosed, being detachably connected to a digital camera module configured to provide a digital image of a scene. In at least one embodiment, the viewing module includes two oculars in which the digital image provided by the camera module may be viewable, the viewing module being adapted for switching the scene viewable in the oculars between an overview of the scene and a detailed view of the scene, where the detailed view of the scene may be a digital still image of the scene. An advantage with at least one embodiment of the invention is that it is possible to use an already available camera, such as a users compact camera, and attach the viewing module, thereby making it unnecessary for the user of the camera to purchase an additional combined camera an binocular as previously known. Instead, the viewing module according to at least one embodiment of the present invention acts as an accessory to the already available camera module, thus providing additional features to an already available camera module.

### FIELD OF THE INVENTION

The present invention relates to a viewing module which is detachably connected to a digital camera module.

### DESCRIPTION OF THE RELATED ART

In using conventional hand-held viewing instruments, the largest useful magnification is restricted by the difficulty experienced by a user holding such handheld instruments sufficiently stable. The slightest shaking movement of the instrument causes the image viewed by the user to shake. In the case of high degrees of magnification, the shaking movements affect the image to such an extent that as to make perception thereof difficult. Hand-held viewing instruments therefore are rarely used for magnification above ten, and a magnification of seven or eight is common for practical purposes. When viewing instruments are used to view objects that appear small against a large background, such as birds or airplanes against the sky, high-magnification instruments may make it difficult to find the objects one wishes to study. High magnification reduces the field of vision.

WO 98/26321 provides a solution to this problem, in which an instrument with the possibility of freezing the instrument-produced image is disclosed. The frozen image may then be studied without inconvenience, even if the instrument itself is subjected to shaking movements. The technique provides the user with the possibility of studying the frozen image in detail under larger magnification. To find the object to be viewed, the viewer uses a low degree of magnification, which provides the user with an overview of the scene. Thereafter, as soon as the user viewer has found the object of interest and preferably centered it to the centre field of the image, the image can be frozen and studied without being subjected to shaking movements.

However, even though the aforementioned prior art provides high functionality, the solution is relatively high-priced, and thus not suitable for the general consumer.

### OBJECT OF THE INVENTION

Therefore, there is a need for an improved viewing instrument, and more specifically to an improved viewing instrument that overcome or at least alleviates the cost problems according to prior art.

### SUMMARY OF THE INVENTION

According to an aspect of the invention, the above object is met by a portable viewing module being detachably connected by means of a mechanical or electrical connection to a portable digital camera configured to capture a digital image of a scene, said viewing module comprising two oculars in which the digital image captured by the camera module is viewable, the viewing module being adapted for switching the scene viewable in the oculars between an overview of the scene and a detailed view of the scene, wherein the detailed view of the scene is a digital still image of the scene.

The present invention is based on the understanding that it may be possible to combine a standard camera module, such as a system, compact camera, or a portable digital camera with an adapter, i.e. the viewing module according to the present invention (which may be portable), for forming a viewing system having the advantages of a binocular and further having zoom and storage capabilities in accordance the camera module being used. The present invention is however not limited to the use of a standard camera as stated above, instead, it would of course be possible to use any other type of detachable camera module.

The physical connection between the viewing module and the camera module may preferably be achieved by adapting a receiving section of the viewing module in such a way that the form factor of a receiving portion fits the form factor of the camera module. However, it would of course be possible to arrange the receiving portion of the viewing module to be adaptable to a various number of different cameras, for example using inserts specifically adapted for each specific camera. The connection may also be electrical by means of an electrical wire.

Advantages provided by the present invention includes the possibility to use an already available camera, such as a users compact camera, and to that attach a viewing module, thereby making it unnecessary for the user of the camera to purchase an additional combined camera an binocular as provided according to prior art. Instead, the viewing module according to the present invention acts as an accessory to the already available camera module, thus providing additional features to the camera module. Hence, the user can choose whether to use the camera as a regular one or as a type of binocular camera. As the viewing module does not comprise expensive electronics it may be manufactured at a relatively low cost, thus making it suitable in a low cost consumer environment. Another advantage with the present invention includes the possibility to use processing power, for example in the form of a control unit, that already is available through the camera module.

Alternatively, the object may be met by a viewing module being detachably connected to a digital camera module configured to provide a digital image of a scene, said viewing module comprising two oculars in which the digital image provided by the camera module is viewable, the viewing module being adapted for switching the scene viewable in the oculars between an overview of the scene and a detailed view of the scene, where the detailed view of the scene is a digital still image of the scene. Accordingly, this viewing module may be useful independently of the initially discussed viewing module.

Preferably, the viewing module may further comprise a control unit for controlling the operation of the camera module and wherein each of the oculars each having a display screen, the display screens being adapted to receive an image signal from the camera module and to provide a viewable representation of the scene, and the control unit is adapted for receiving a control signal for switching the scene viewable in the oculars.

The camera module being detachably connected to the viewing module according to the present invention may preferably be equipped with an image sensor in the form of for example a CMOS or CCD image sensor. The sensor used in the camera module can depend on the cost segment, where the CMOS sensor generally is cheaper but than also potentially, presently, provide a result having lower quality than a CCD sensor.

Furthermore, since the viewing module according to the present invention provides a moving overview image of the scene it simplifies for the user to obtain a general view and to find an object for the user in an overview search mode, when photographing for instance birds, compared to the case when using a regular camera.

Preferably, the viewing module further comprises two display screens arranged together with each of the oculars, wherein the displays are adapted to receive an image signal from the camera module and to provide a viewable representation of the scene. Similar to the physical connection provided between the camera module and the viewing module according to the present invention, the viewing module may preferably be provided with an electrical connection, wired or wireless, for providing the viewing module with a digital representation of the image captured using the camera module.

In an embodiment, the displays and the oculars are arranged in direct contact with each other, however, that may not be necessary. Instead it can possibly be some distance between each of the displays and each of the oculars, for example by inserting an optical guide between the displays and the oculars. Further, the image signal may be analog using e.g. VGA or digital using e.g. USB or Firewire.

In a preferred embodiment, the overview of the scene may be provided by the camera module using a first lens having a first predetermined magnification, and the detailed view of the scene may be provided by the camera module using a second lens having a second predetermined magnification, the first magnification being lower than the second magnification. However, it would also be possible to use a combined zoom lens, providing both the first and the second magnification, for example in the form of a motorized zoom lens possibly controlled using a control unit comprised in the viewing module. Using this type of combined lens makes the end product simpler and more cost efficient. Also, and as is understood by the skilled addressee, the first lower magnification may be used for providing the overview of the scene. In an embodiment of the invention, the camera module further comprises communication circuitry and an antenna providing wireless communication between the camera module and another electronic unit. Such an arrangement may especially be useful when the user transfers a captured image between the camera module and an externally arranged electronic unit, for example in the form of a laptop or a personal computer. In a preferred embodiment of the present invention the camera module may be a mobile telephone comprising a digital camera. As such, it may be possible to use the built in communication circuitry and antenna for providing wireless communication with the external electronic unit.

Using the digital camera of a mobile phone instead of a regular digital camera has further advantages, for example there may be no need for an extraordinary camera, which comprises wireless communication possibilities. Instead, existing circuitry and camera functionality of the mobile phone may be utilized. For the end consumer this may be better, as camera equipped mobile phones are commonly available, thus resulting in a less expensive end system. Furthermore, in one embodiment of the present invention the viewing module comprises one lens, or more preferably a system of lenses, arranged in front of a lens of the camera module. The lens system may be adapted to provide additional zoom capabilities. In the case of the camera module being a mobile phone comprising a digital camera it might be useful to have the additional lens system adapted to compensate for the potential down scaling commonly performed by the mobile phone camera.

In another preferred embodiment, the viewing module further comprises two additional lenses that are optically connected to each of the oculars, respectively, where the additional lenses has a third predetermined magnification and are arranged to provide an overview of the scene. This combination of two additional lenses that are optically connected to each of the oculars may be used as a pair of binoculars with a photographing function, potentially providing a better “tracking” when in an overview mode. Also, the use of two additional lenses potentially provides the user of the viewing module with a sense of depth information generally present when using a normal binocular. Furthermore, the additional lenses can possibly be adapted to provide the above discussed overview of the scene. Preferably the control unit is further adapted for switching the view provided through the oculars between the image provided by the camera module and the overview of the scene provided by the additional lenses. It would be possible, and within the scope of the invention, to use an over dimensioned camera sensor which generates an image that may be over dimensioned in relation to the digital displays in the viewing module. Then, when using the overview setting the image may be downscaled to fit to the display. When using the detail view setting, the image viewable in the display may only be a, by the user selected, part of the over dimensioned image. For instance, the over dimensioned image could have QVGA-resolution and the display VGA-resolution.

Supplementary storage capabilities may be provided by the viewing module by comprising digital storage means in addition to the digital storage means provided by the camera. Such additional digital storage means may be an USB or a flash memory card, e.g. CompactFlash, Memory Stick, Secure digital etc.

Furthermore and as discussed above, the viewing module according to the present invention is preferably detachably connected to a mobile phone having camera capabilities, thereby forming a viewing system. As understood by the skilled addressee, it would of course be possible, and within the scope of the present invention, to use a different type of camera than the camera equipped mobile phone.

According to an alternative embodiment of the invention, there is provided an optical system, comprising a portable digital camera module adapted to capture a first view of a scene, and a portable viewing module as discussed above further comprising means for capturing a second view of the scene. The optical system may further comprise a first tubular member at one end connected to at least one of the oculars and at the second end connected to the portable digital camera module, and a second tubular member at one end connected to the at least one ocular and at the second end connected to the portable viewing module, thereby allowing for a user of the optical system to view both the first and the second view of the scene.

This alternative embodiment of the invention is based on the understanding that the human peripheral vision is rather weak, and that by dividing the field of vision for the user, in a similar manner as in relation to bifocal glasses, it may be possible to allow for the user to view both the first and the second view of the scene. Thus, in a first mode, e.g. an overview mode, the user of the optical system position the center of his field of view, i.e. center of gaze, to essentially coincide with the center axis of the first tubular member, wherein the user will view the first, possibly magnified at a low level, view of the scene. At this point, the image provided through the second tubular member will reside in the periphery vision of the user, and thus not disturb the first view, e.g. overview, of the scene.

Therefore, if for example arranging the center axis of the first tubular member in a horizontal plane, and positioning the center axis of the second tubular member at a lower level, it may be possible for the user to repositioning the center of his gaze to coincide with the center axis of the second tubular member. At this point, in a second, possible detailed, mode, the image provided through the first tubular member will fall into the user's periphery vision and thus not disturb the user when looking at the second view through the second tubular member.

An advantage is that the introduction of the two tubular members eliminates the need for introducing complex elements in the optical system, thereby resulting in a less expensive end product suitable in a low cost consumer environment. As mentioned above, the first view of the scene is preferably an overview of the scene, and the second view of the scene is preferably a detailed view of the scene. Furthermore, if the first view of the scene for example is provided at a first magnification level, and the second view is provided at a second magnification level, the first magnification level being lower then the second magnification level, the first image of the scene simplifies for the user to obtain a general view and to find an object for the user in an overview “search” mode, when photographing for instance birds, compared to the case when using a regular camera. Preferably, the first view of the scene may be selected to have a magnification level between one and eight, and the second view of the scene may be selected to have a magnification level between approximately eight and 16. Other magnification levels are of course possible and within the scope of the present invention.

The first and the second tubular member are preferably cylindrical, i.e. like a pipe. However, it may of course be possible to use other type of shapes, such as tubular members having a squared, pentagonal, hexagonal, or different section surface.

It should also be noted that the optical system may be arranged as a separate arrangement, i.e. not comprising the portable viewing module as discussed above. In such a case the optical system may be arranged to comprise a first optical module adapted to provide a first view of a scene, a second optical module adapted to provide a second view of the scene, and a viewfinder, wherein the optical system further comprises a first tubular member at one end connected to the viewfinder and at the second end connected to the first optical module, and a second tubular member at one end connected to the viewfinder and at the second end connected to the second optical module, thereby allowing for a user of the optical system to view both the first and the second view of the scene. This separate arrangement may be useful independently of the viewing module as discussed above.

Preferably, the portable viewing module comprises a telescope module for providing a direct view of the scene, and the portable camera module comprises a display unit for displaying a digital image of the scene captured using an image sensor, and wherein the second tubular member at its second end connects to the telescope module, and the first tubular member at its second end connects to the display unit. It will thereby be possible for a user of the optical system to view both the digital still image of the scene and the direct view of the scene. Using an image sensor for capturing a digital, e.g. detailed view of the scene provides, for example for the possibility to store the detailed view of the scene for later playback. It should be noted that a video sequence comprises a plurality of still images, and thus, the displays are adapted to display a stream of digital still images. The digital still image may preferably be a detailed view of the scene being magnified for example magnified eight to 16 times. As mentioned above, other magnification levels are of course possible and within the scope of the present invention.

It may be advantageous if an angle between the center axis of the first and the second tubular members are at least 10 degrees. However, the angle between the two tubular members may preferably be adjustable between 5 and 45 degrees. This allows different users to adapt the optical systems based on for example their periphery vision.

For further enhancing the direct view of the scene, the optical system according to the present invention further comprises means for turning on and off the display unit. By turning off the display when in overview mode the display becomes dark and the user of the optical system may not be disturbed by the light coming from the display when looking at the scene in overview mode. On the other hand, when turning on the display for looking at a detailed view of the scene, the switching of the display from off to on will catch the attention of the user such that he will reposition the center of his field of view to become essentially parallel to the center axis of the second tubular member that may be connected to the display unit.

The optical system may further comprise a lens arranged in front of the image sensor, thereby providing additional zoom capabilities. Such a lens, for example a combined zoom lens providing multiple magnification levels (e.g. a motorized zoom lens) may be controlled using the control unit. Additionally, the optical system may be further equipped with communication circuitry and an antenna for providing wireless communication between the optical system and another electronic unit. Such an addition may be especially useful when the user transfers a captured image between the optical system and an externally arranged electronic unit, e.g. between the optical system and a laptop or a personal computer.

Alternatively, the image sensor may be comprised in a housing, e.g. forming a camera, which may be detachably connected to the optical system, thereby making it possible to use an already available camera. By providing for the possibility to use an already available camera, such as a compact camera or a mobile phone having camera capabilities, and to that attach the camera to the reminder of the optical system, it will be unnecessary for the user of the camera to purchase an additional combined camera and optical system as provided according to prior art. Instead, the optical system according to the present embodiment acts as an accessory to the already available camera, thus providing additional features to the camera. Hence, the user can choose whether to use the camera as a regular one or as a type of optical system. In such a case, the reminder of the optical system does not have to comprise expensive electronics and can thus be manufactured at a relatively low cost, making it suitable in a low cost consumer environment.

The first optical module may also comprise a first telescope module for providing a direct view of the scene, and the second optical module comprises a second telescope module for providing a detailed view of the scene. Such an embodiment may for example be useful in relation to a sight for a firearm, wherein the user for example may be provided with both an overview of the scene and a detailed view of the scene, all without having to move his focus from the optical system. An advantage with this embodiment is that no electrical power has to be provided, conversely to the case where the optical system comprises an image sensor and a display unit. It should be noted that it also may be possible, and within the scope of the invention, to use a first display connected to the first tubular member, and a second display connected to the second tubular member, where the displays are arranged to provide images for example having different resolution or displayed at different zoom levels. In such a case, the optical system may be completely digital and both modes displays digital images of the scene, preferably at different magnification levels and/or at different resolution levels. However, alternatively the first view may be digital and the second view may be provided by a telescopic module.

The optical system may preferably, but not exclusively, be arranged as a component in a binocular arrangement. In such an embodiment, the binocular arrangement may be adapted to comprise two optical systems as discussed above, wherein the viewfinder of each of the optical systems are positioned such that the eyes of a user of the binocular arrangement coincide with each of the viewfinders.

Such a binocular arrangement provides the user not only with a stereoscopic overview of the scene, but also a detailed stereoscopic view of the scene. If providing the binocular arrangement with appropriate storage means, it may thus be possible to record a stereoscopic sequence which thereby will allow for the rendering of three-dimensional computer based images, or for reviewing the captured stereo images using appropriate stereoscopic equipment known in the art.

However, alternatively the binocular arrangement instead comprises one optical system according to the present invention, a further display unit for displaying a digital still image, a further telescope module for allowing a direct magnified view of the scene, a further viewfinder, a third tubular member at one end connected to the further viewfinder and at the second end connected to the further display unit, and a fourth tubular member connected at one end to the further viewfinder and at the second end to the further telescope module, wherein the digital still image captured by the image sensor may be displayed on the further display unit.

Accordingly, only one image sensor may be used for capturing a digital image which in turn may be displayed on both the displays. Even though this embodiment in some sense provides a loss in relation to the stereoscopic capturing capabilities, the use of only one image sensor will provide a more compact binocular arrangement and also a less expensive product. It should be noted that it also would be possible to use only one display for both eyes, and arrange optical guidance means (e.g. prisms) for directing the image displayed on the only one display through each of the first and the third tubular members to each of the respective eyes of the user.

As stated above, each of the viewfinders are preferably arranged to coincide with the eyes of the user of the binocular arrangement. Therefore, the binocular arrangement preferably includes an interpupillary distance adjustment mechanism to accommodate multiple users. Accommodation for vision correction and a focus mechanism may also be provided.

### BRIEF DESCRIPTION OF THE DRAWINGS

These and other aspects of the present invention will now be described in more detail, with reference to the appended drawings showing currently preferred embodiments of the invention, in which:

FIG. 1 is a conceptual block diagram of a viewing system comprising a viewing module according to an embodiment connected to a camera module;

FIG. 2 shows a perspective view of a viewing module according to an embodiment of the present invention, where a mobile phone camera is partially inserted in the viewing module;

FIG. 3 shows a perspective view of a viewing module according to another embodiment of the present invention, where a mobile phone camera is fully inserted in the viewing module;

FIG. 4 is a conceptual block diagram illustrating an optical system according to an alternative embodiment of the present invention; and

FIGS. 5a and 5b are views of an exemplary embodiment of the optical system illustrated in FIG. 4.

### DETAILED DESCRIPTION OF CURRENTLY PREFERRED EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

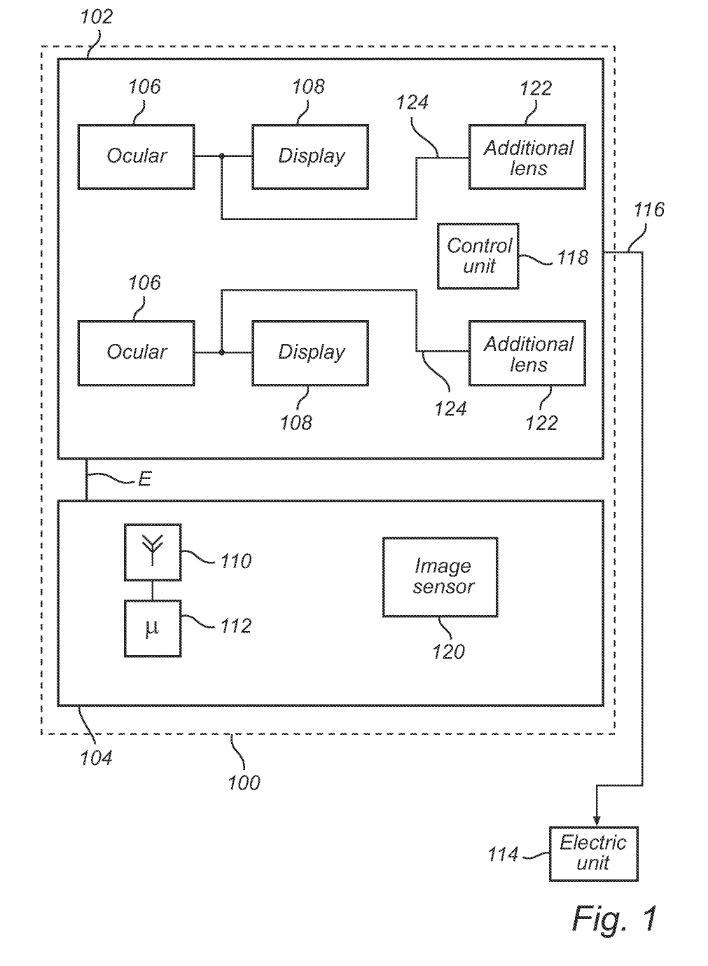

Referring now to the drawings and to FIG. 1 in particular, there is depicted a block diagram of a viewing system 100. The viewing system 100 comprises a viewing module 102 according to an embodiment of the present invention and a camera module 104, the camera module 104 being detachably connected to the viewing module 102. Furthermore, the viewing module 102 comprise two oculars 106 in which a digital image captured by the camera module 104 may be viewable, preferably by looking through the oculars 106 onto two display screens 108 which each are arranged together with the oculars 106. It would however be possible to integrate the oculars and the displays as one part, for example by using display screens 108 adapted to allow for a user to in one state see through the display screens 108, and in another state view the digital image on the display screens 108. Such an implementation may for example be possible using LCD display screens. As such, it should be noted that the definition of the oculars 106 should be interpreted as a kind of eyepieces having functionality that provides for blocking out a large portion of external light such that the user more easily can view the display screens 108.

As mentioned above, the camera module 104 is preferably an already existing camera, such as for example a system camera, a compact camera, or a mobile phone having camera capability. By using an already existing camera it may be possible to use the available image capturing functionality, and thereby provide a captured digital image of a scene to the display screens 108 arranged together with the oculars 106. The connection between the viewing module 102 and the camera module 104 may thus not only be physical, but also electrical, denoted E, for example by means of a wired or wireless connection. Different electrical connections are available, including for example wired connections like USB, FireWire, VGA, or similar, and wireless connections like WLAN, Bluetooth, infrared, or similar. It is understood by the skilled addressee that the art provides numerous different possibilities in regards to the electrical connection between the viewing module 102 and the camera module 104, thereby allowing for the type of camera module 104 used to decide on which electrical connection that should be implemented.

In the presently illustrated embodiment, the camera module 104 is a mobile phone having camera capabilities, thus preferably comprising an antenna 110 and processing means 112 for allowing to transfer captured images from the camera module 104 to an externally arranged electronic unit 114, for example in the for of a portable or stationary computer, such as a laptop, a Personal Digital Assistant (PDA), or a desktop. Using the inbuilt mobile functionality, for example using mobile transmission means (e.g. CDMA, GSM, 3G, or similar), it may also be possible to transfer the captured image to a remotely located electronic unit, for example a remote server.

However, it may also be possible, and within the scope of the invention, to use a camera module 104 without having the possibility to transfer images directly to the external electronic unit 104. In such a case, the viewing module 102 may be equipped with a similar antenna and processing means as discussed above. In any case, the viewing module 102 preferably comprises a wired output 116 for providing transfer of the image viewable on the display screens to the external electronic unit 114. Similar wired interfaces as described above may be used.

The viewing module preferably comprises a control unit 118 for controlling the communication between the viewing module 102 and the camera module 104, for controlling the communication between the viewing module 102 and the external electronic unit 114, and for controlling the functionality of the viewing system 100. The controlling of the functionality of the viewing system 100 includes controlling the display screens 108, and for switching the viewing state between an overview of the scene and a detailed view of the scene.

The control unit 118 may include a microprocessor, a microcontroller, a programmable digital signal processor or another programmable device. The control unit 118 may also, or instead, include an application specific integrated circuit (ASIC), a programmable gate array programmable array logic, a programmable logic device, or a digital signal processor. Where the control unit 118 includes a programmable device such as the microprocessor or microcontroller mentioned above, the processor may further include computer executable code that controls operation of the programmable device.

In a preferred version of the viewing system 100, both the overview of the scene and the detailed view of the scene are provided by means of the camera module 104. In one case a motorized lens may be connected to an image sensor 120 of the camera module, and the switching between the overview and the detailed view if provided by adjusting the magnification of the motorized zoom lens between a lower magnification and a higher magnification. The lower magnification for providing the overview of the scene can for example be predetermined to be around four times, and the detailed view of the scene can for example be predetermined to be around 16 times. It would however be possible to use different magnification levels, however, the detailed view of the scene should preferably be kept to less than six times magnification, as a higher magnification level will be sensitive to shaky movements. This may however not always be necessary.

In another preferred embodiment an oversized image sensor 120 may be used, thereby, in a general case, making it unnecessary to use a motorized zoom lens. It would however be possible to combine an oversized image sensor 120 and a motorized zoom lens. When using an oversized image sensor 120, the camera module 104 captures, in the overview state, a digital image that may be lager that what may be possible to display on the display screens 108. Therefore, when switching to the detailed state, only a small portion of the image provided by the image sensor need to be provided to the display screens 108. In an exemplary embodiment the display screens are arranged to display a digital image having a size of 640 times 480 pixels, and the image sensor 120 may be able to capture a digital image having a size of 5120 times 3840 pixels, i.e. the image sensor 120 can capture eight times the image information that may be viewable on the display screens 108. By downscaling the captured image eight times, i.e. a 8:1 downscaling, the overview of the scene in provided. Then, when switching to the detailed view of the scene, only a 640 times 480 “window” of the originally captured image may be made viewable on the display screen, thereby zooming in the image without degenerating the result due to digital zoom. Actually, the resolution viewable on the display screens increases in the switching from the overview of the scene to the detailed view of the scene as the downscaling of the oversized image generally includes a calculation of a mean value for neighboring pixels.

In still another preferred embodiment, the viewing module may further and optionally be equipped with two additional lenses 122 for providing an “analog” overview of the scene. This analog overview may be useful in some cases where the image sensor 120 provides an insufficient video signal, i.e. a continuous stream of captured digital images but provides still images having a desired quality. In this embodiment, the viewing module 102 may also be provided with optical connectors 124 between the additional lenses 122 and the oculars 106, and also with functionality for switching between the image provided by means of the display screens 108 and the analog image provided by the additional lenses 122. In such a case, the LCD display screens discussed above could be used, or movable display screens that in one state are positioned on the optical path between the oculars 106 and the additional lenses 122 (i.e. in the detailed view of the scene), and another state where the movable display screens are positioned away from the optical path between the additional lenses 122 and the oculars 106. The analog overview provided by means of the additional lenses 122 can have a magnification factor of about four times, but other magnification factors are possible and within the scope of the invention.

When switching between the overview of the scene and the detailed view of the scene, a crosshair, or similar, may be used for indicating the center of the overview. Thus, when in overview mode, the user may “aim” the crosshair at a point in the scene that may be of interest, and then switch to the detailed view of the scene, which then will provide a detailed display of the an area having the same center as the crosshair had in the overview of the scene. Other method are known in the art.

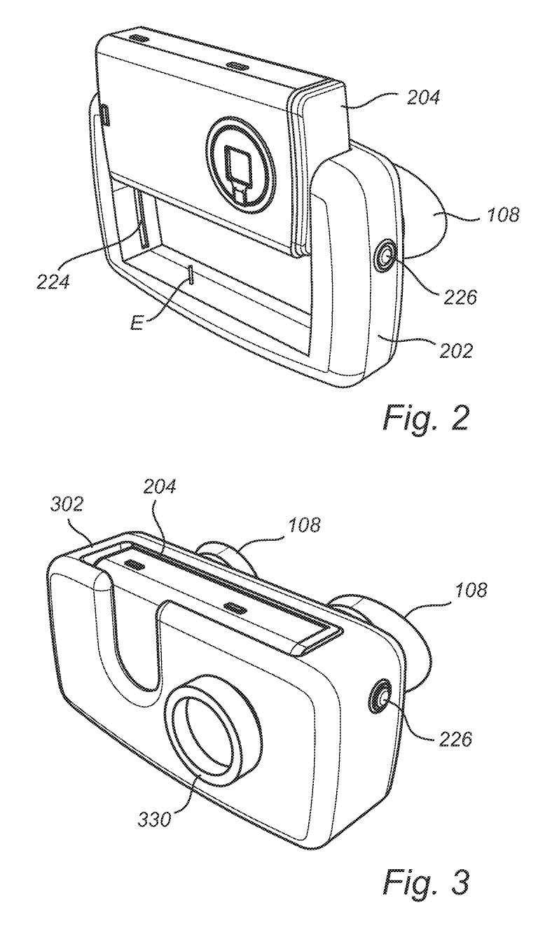

Turing now to FIG. 2 which shows a perspective view of a viewing module 202 according to an embodiment of the present invention, wherein a mobile phone camera 204 may partially be inserted into the viewing module 202 by means of guiding means 224 inside the viewing module 202. As mentioned above, the viewing module 202 comprises two oculars 108 (only one viewable in FIG. 2) in which a digital image provided by the mobile phone camera may be viewable. On one side of the viewing module 202 a push-button 226 may be provided for switching the scene viewable in the oculars between the overview of the scene and the detailed view of the scene. The push-button 226 may preferably be connected to the control unit 116. The electrical connection between the viewing module 202 and the camera module 204 is denoted E.

Another preferred embodiment of a viewing module 302 is shown in FIG. 3, in which a mobile phone camera is fully inserted in the viewing module. In this embodiment, the viewing module 302 has been equipped with an additional lens 330 arranged in front of the camera lens of the mobile phone 204. As discussed above, the additional lens (or lens system) may be adapted to provide additional zoom capabilities, and for compensating for the potential down scaling possibly performed by the mobile phone camera. The viewing module in FIG. 3 has furthermore been equipped with additional guiding means for essentially enclosing the mobile phone 204 in the connected state.

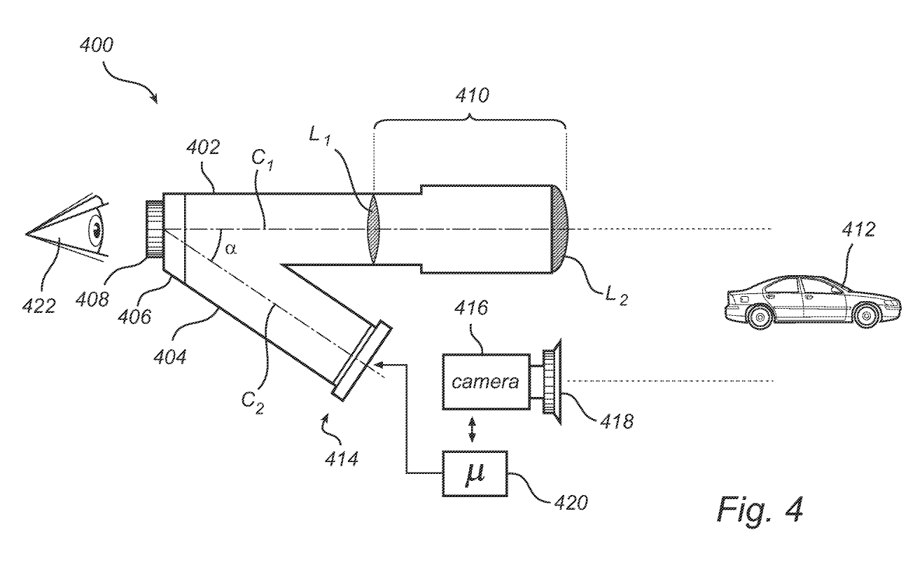

An alternative embodiment is illustrated in FIG. 4, where there is provided a conceptual illustration of an optical system 400. The optical system 400 comprises a first tubular member 402 and a second tubular member 404. Each of the tubular members 402, 404 have a center axis C₁, C₂, respectively. A first end of each of the tubular members 402, 404 may be connected to a viewfinder 406, onto which also a ocular 408 may be arranged. At the second end of the first tubular member 402, a first optical module may be arranged, in the present embodiment a telescope module 410 adapted for providing a direct view of a scene, for example the car 412 shown in FIG. 4. The telescope module generally comprises a complex lens system, in FIG. 4 illustrated using two lenses L₁, L₂. The skilled addressee understands that different lens arrangements are possible, and within the scope of the invention.

At the second end of the second tubular member 404 a second optical module may be provided, in the present embodiment a display unit 414 for displaying a digital image or a video sequence. The display unit 414 preferably comprises a display panel and a backlight arranged behind the display panel, e.g. forming an LCD. The digital image, or video sequence, may be provided by a digital camera 416 comprising an image sensor, for example a CCD or a CMOS sensor. The digital camera 416 may preferably be arranged to overlook the same scene as the telescope module 410, for example the car 412. Preferably, the telescope module 410 provides an overview of the scene, and the digital camera 416 provides a detailed view of the scene. In the illustrated embodiment, the camera may be provided with a motorized lens 418. A lens having a fixed magnification may also be possible.

The optical system 400 further comprises a control unit 420 for controlling the display unit 414, the digital camera 416, and the communication between the display unit 414 and the digital camera 416. As discussed above, the control unit 420 may include a microprocessor, a microcontroller, a programmable digital signal processor or another programmable device or any other similar device.

Also, the optical system 400 can comprise storage means for storing the images/video sequences captured using the digital camera 416, and be provided with communication means for transmitting captured images and video sequences to an external unit, for example in the form of a portable or stationary computer, such as a laptop, a Personal Digital Assistant (PDA), or a desktop. The transmission may be wired or wireless, including for example wired connections like USB, FireWire, VGA, or similar, and wireless connections like WLAN, Bluetooth, infrared, or similar. As discusses above, it may be possible, and within the scope of the invention, to use an already existing digital camera. An example of such a camera may be a mobile phone having camera capability. Using a mobile phone, it may also be possible to use the inbuilt mobile functionality, for example using mobile transmission means (e.g. CDMA, GSM, 3G, or similar), to transfer the captured image to a remotely located electronic unit, for example a remote server.

In the illustrated version of the optical system 400, the overview of the scene may be provided using “analog means”, i.e. using the telescope module 410, and the detailed view may be provided using “digital means”, i.e. the digital camera 416. It would however be possible to provide different combinations, e.g. analog overview—analog detailed view, digital overview—analog detailed view, or digital overview—digital detailed view.

The overview of the scene may be provided at a low magnification level, for example may be predetermined to be around four times, and the detailed view of the scene can for example be predetermined to have a magnification level around 16 times. It would also be possible to use different magnification levels. However, the detailed view of the scene should preferably be kept to less than six times magnification, as a higher magnification level will be sensitive to shaky movements.

In another preferred embodiment the digital camera 416 may be equipped with an oversized image sensor. When using an oversized image sensor, the digital camera 416 captures a digital image that may be larger that what may be possible to display on the display unit 414. This allows for the possibility to pan and tilt in the detailed view of the scene. In an exemplary embodiment the display unit 414 may be arranged to display a digital image having a size of 640 times 480 pixels, and the image sensor may be able to capture a digital image having a size of 5120 times 3840 pixels, i.e. the image sensor can capture eight times the image information that may be viewable on the display unit 414.

During operation, a user of the optical system 400 positions his eye 422 in connection with the ocular 408. In “overview mode”, the user looks straight forward (i.e. gaze parallel to C₁), and thus the overview of the scene will be visible through the telescope module 410. By repositioning his gaze, preferably downwards (other directions are possible), the detailed view of the scene displayed on the display unit 414 will fall into the users field of view, thereby entering the “detailed mode”. As discussed above, the view not currently in the user's field of view will instead fall into the periphery vision of the user, and thus not disturb the view currently in the user's field of view (i.e. gaze parallel to C₂). An angle α between the center axis C₁, C₂, of the two tubular members 402, 404 may preferably be at least 10 degrees. However, depending on the user, the angle α may preferably be adjustable between five and 45 degrees.

For further enhance the user experience, the optical system 400 preferably comprises means for turning on and off the display unit 414. Such means, for example a button or a switch, may preferably be connected to the control unit 420. Furthermore, the overview of the scene may preferably be provided with a crosshair, or similar, for indicating the center of the overview. Thus, when in overview mode, the user may “aim” the crosshair at a point in the scene that may be of interest, and then reposition his gaze to the detailed mode where it will be displayed an area having the same center as the crosshair had in the overview of the scene. Also, and as discussed above, it may be possible to combine two optical systems 400 for use as a binocular having dual functionality. In such a binocular, it might not be necessary to use two digital cameras, and thus, one of the digital cameras may be omitted.

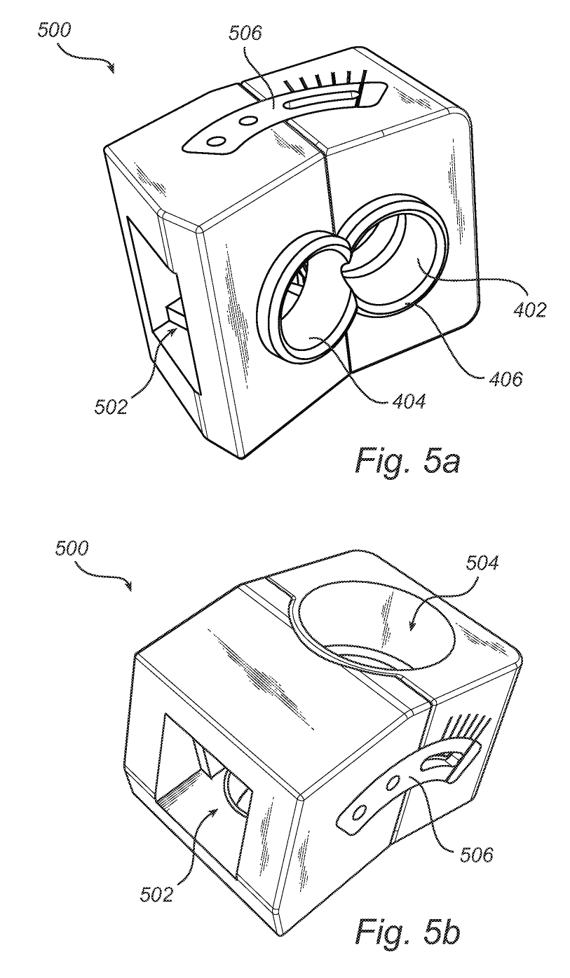

Turning now to FIGS. 5a and 5b which shows two different perspective views of still another exemplary optical system 200 according to the present invention. The viewfinder 406 may, as discussed above, be connected to the first and the second tubular members 402, 404. In FIG. 5a, no ocular is illustrated, but it would be possible to arrange an ocular in connection to the viewfinder 406. On one side of the optical system 500, there may be provided a first compartment 502 for arranging the display unit 414, and on another side of the optical system 500, there may be provided a second compartment 504 for arranging the tubular module 410. Furthermore, the optical system 500 may be provided with adjustment means 506 for adjusting the angle α between the center axis C₁, C₂ of the first and the second tubular members 402, 404, respectively.

The skilled addressee realizes that the present invention by no means is limited to the preferred embodiments described above. On the contrary, many modifications and variations are possible within the scope of the appended claims. For example, it may be possible to provide the viewing module, viewing system, optical system, or the camera module with night vision capability, thereby allowing for the possibility to better view objects in dimly lit or night environment. Also, for extra storage capacity, the viewing module and/or the optical system may be equipped with digital memory means. Furthermore, the digital still images captured using the camera module may be processed and enhanced using different digital image processing methods known in the art, preferably by means of the control unit comprised in the viewing module according to the present invention.

1. A portable viewing module, being detachably connectable by way of a mechanical or electrical connection to a portable digital camera module configured to capture a digital image of a scene, said viewing module comprising:
two oculars in which the digital image of the scene captured by a camera module is viewable, the viewing module being adapted to switch the scene viewable in the oculars between an overview of the scene and a detailed view of the scene, wherein the detailed view of the scene is a digital still image of the scene.

2. Viewing module according to claim 1, further comprising a control unit for controlling the operation of the camera module and wherein each of the two oculars each include a display screen, the display screens being adapted to receive an image signal from the camera module and to provide a viewable representation of the scene, and wherein the control unit is adapted for receiving a control signal for switching the scene viewable in the oculars.

3. Viewing module according to claim 1, wherein the overview of the scene is provided by the camera module using a first lens having a first magnification, and wherein the detailed view of the scene is provided by the camera module using a second lens having a second magnification, the first magnification being relatively lower than the second magnification.

4. Viewing module according to claim 3, wherein the first lens and the second lens are the same lens having adjustable magnification.

5. Viewing module according to claim 1, wherein at least one of the portable viewing module and the portable digital camera module further comprises communication circuitry and an antenna for providing wireless communication between the camera module and another electronic unit.

6. Viewing module according to claim 1, wherein the portable digital camera module is a mobile telephone comprising a digital camera.

7. Viewing module according to claim 1, wherein the viewing module further comprises a lens arranged in front of a lens of the camera module, thereby providing additional zoom capabilities.

8. Viewing module according to claim 2, wherein the viewing module further comprises two additional lenses optically connected to each of the two oculars, respectively, the additional lenses having a third magnification and being arranged to provide an overview of the scene.

9. Viewing module according to claim 8, wherein the control unit is further adapted to switch the view provided through the two oculars between the image provided by the camera module and the overview of the scene provided by the additional lenses.

10. A viewing system, comprising:
a viewing module according claim 1 and a mobile telephone including the portable digital camera module.

11. An optical system, comprising:
a portable digital camera module adapted to capture a first view of the scene;
a portable viewing module according to claim 1, further comprising at least one device to capture a second view of the scene;
a first tubular member, at one end connected to at least one of the two oculars and at a second end connected to the portable digital camera module; and
a second tubular member, at one end connected to the at least one of the two oculars and at a second end connected to the portable viewing module, thereby allowing for a user of the optical system to view both the first and the second view of the scene.

12. Optical system according to claim 11, wherein the portable viewing module further comprises a telescope module to provide a direct view of the scene, wherein the portable camera module comprises a display unit to display a digital image of the scene captured using an image sensor, wherein the second tubular member at its second end connects to the telescope module, and wherein the first tubular member at its second end connects to the display unit.

13. Optical system according to claim 11, wherein an angle between a center axis of the first and the second two tubular members is at least 10 degrees.

14. Optical system according to claim 11, wherein the control unit is adapted to turn the display unit on and off.

15. Optical system according to claim 12, wherein the image sensor is at least one of a CCD sensor and a CMOS sensor.

16. Optical system according to claim 12, further comprising a lens arranged in front of the image sensor, thereby providing zoom capabilities.

17. Viewing module according to claim 1, wherein the overview of the scene is provided by the camera module using a first lens having a first magnification, and wherein the detailed view of the scene is provided by the camera module using a second lens having a second magnification, the first magnification being relatively lower than the second magnification.

18. Viewing module according to claim 2, wherein the viewing module further comprises two additional lenses optically connected to each of the two oculars, respectively, the additional lenses having a third magnification and being arranged to provide an overview of the scene.

19. Optical system according to claim 12, wherein an angle between a center axis of the first and the second two tubular members is at least 10 degrees.
